(19) United States
(12) Patent Application Publication
(10) Pub. No.: US 2010/0110051 A1
(43) Pub. Date: May 6, 2010

(54) CONTROL METHOD FOR LENS DRIVE SCREEN

(75) Inventors: CHIEN MING-FAR, Taipei County (TW); Al Keng-Hung, Taipei County (TW)

Correspondence Address: YH CHAN, 42 PIN OAKS DRIVE, PHOENIXVILLE, PA, 19460, US

(73) Assignee: YI JHAO TECHNOLOGY CORPORATION, Taipei County (TW)

(21) Appl. No.: 12/261,065

(22) Filed: Oct. 30, 2008

(51) Int. Cl. G09G 5/00

(52) U.S. Cl. 345/207

(57) ABSTRACT

The present invention provides a control method and its system of lens drive screen, wherein a lens connected to electronic device is displaced, then a displacement signal is generated and sent to the microprocessor of electronic device for identification, and then the displacement signal is converted into a control signal to control the display screen of the electronic device; the system mainly comprising: a lens, used for acquiring initial images and shift images; a control program, loaded into an electronic device; it employs shape detection algorithm and target tracking algorithm to position the initial images and track the varying shift, rotation or zooming of the lens as well as the relative displacement, and convert it into a displacement signal to the electronic device; then, the microprocessor of the electronic device converts the displacement signal into a control signal so as to control on-screen operation by the application.

### BACKGROUND OF THE INVENTION

The present invention relates generally to a screen control technology, and more particularly to a control method and system of lens drive screen which permits positioning and calculation of initial images of the lens through a control program to obtain a displacement value, then convert it into a displacement signal and transmit to the microprocessor, allowing for converting into a control signal so as to control the screen by the applications.

Conventionally, the game software or applications must be loaded into an electronic device (e.g. computer) or stored into a memory card, and a compatible electronic device should be built-in for game control; the user can transmit signals by operating the keyboard or joystick to control the shift, rotation or zooming of targets in the game screen. However, there is a lack of interaction between the users and games, let alone insufficient actual experience in the game process.

With the development of science and technology, new sensing modes have been developed continuously, especially Wii of Nintendo and iPhone of Apple. As for the former one, the remote controller is allowed for 360° sensing in replacement of joystick and keyboard. As for the latter one, the mobile phones could be placed horizontally or vertically, and the screen could be adjusted automatically to sense the directional change. The technical principle of such micro-electromechanical sensing system is that highly sensitive magnet is introduced to the sensor components, in other words, the sensing is based on the magnetic field to further determine the motion direction and positioning. Today, the sensing principle and mechanical inertia are adopted by the most popular Wii games; when the remote controller generates acceleration through manual movement, the cross bar in the three-axle sensor chip will shift reversely, leading to the change of capacitance value; then, the gravity acceleration is computed, meanwhile the infrared sensor and Bluetooth are used to send signals to the host computer. But, such game is very expensive owing to high cost of three-axle sensor chip.

Furthermore, new iPhone mobile phones shall be adopted to realize the same functions, along with higher hardware and manufacturing cost; but nonsynchronous situation often occurs since the visual reaction is not considered during mobile phone sensing process.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The primary objective of the present invention is to replace the traditional screen control modes including keyboard, joystick or remote controller.

Another objective of the present invention is to synchronize the operation, visualization and screen control without additional hardware and brand-new models.

The control method and system of lens drive screen of the present invention is technically characterized in that:

When a lens connected to electronic device is displaced, the control program generates a displacement signal to the microprocessor of electronic device for identification, and then the displacement signal is converted into a control signal to control the screen of the electronic device. The system mainly comprises a lens for acquiring initial images and shift images; a control program, loaded into an electronic device, which employs shape detection algorithm and target tracking algorithm to position the initial images and track the varying shift, rotation or zooming of the lens as well as the relative displacement, and convert it into a displacement signal to the electronic device; then, the microprocessor of the electronic device converts the displacement signal into a control signal so as to control on-screen operation.

### BRIEF DESCRIPTION OF THE DRAWINGS

FIG. 1: an outside view of a preferred embodiment of the present invention.

FIG. 2: a schematic view of the system of the present invention.

FIG. 3: a flow process chart of the method of the present invention.

FIG. 4: a schematic view of the system control program of the present invention.

FIG. 5: a schematic view of detection and tracking status of the present invention.

FIG. 6: an operating status view of the present invention.

FIG. 7: an operating status view of the present invention.

### DETAILED DESCRIPTION OF THE INVENTION

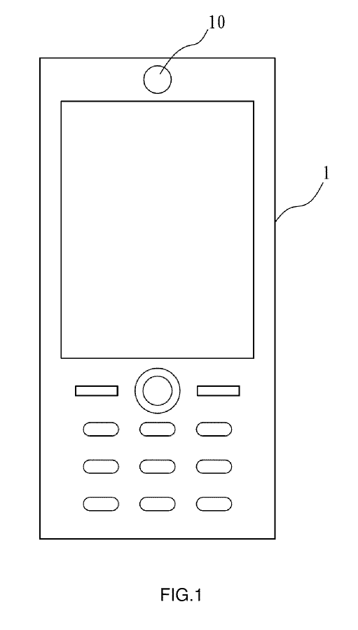

Referring to FIG. 1, the lens drive screen control system of the present invention, wherein the system comprising: a lens 10 and a control program 11. The lens 10 is connected to an electronic device 1, and used as an element for acquiring initial images and shift images of the lens 10; the control program 11 is loaded into an electronic device 1, which processes the images acquired from the lens 10, employs shape detection algorithm and target tracking algorithm to position the initial images and track the varying shift, rotation or zooming of the lens as well as the relative displacement, and convert into a displacement signal to the electronic device 1; then, the microprocessor of the electronic device 1 converts the displacement signal into a control signal so as to control on-screen operation.

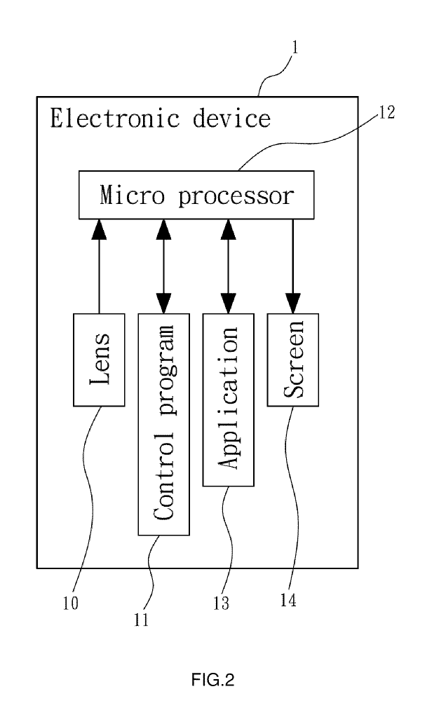

Referring to FIG. 2, the lens drive screen control method of the present invention, wherein a lens 10 connected to electronic device 1 is displaced, the control program 11 generates a displacement signal to the microprocessor 12 of electronic device 1 for identification, and then the displacement signal is converted into a control signal to control the screen 14 of the application 13 implemented by the electronic device 1.

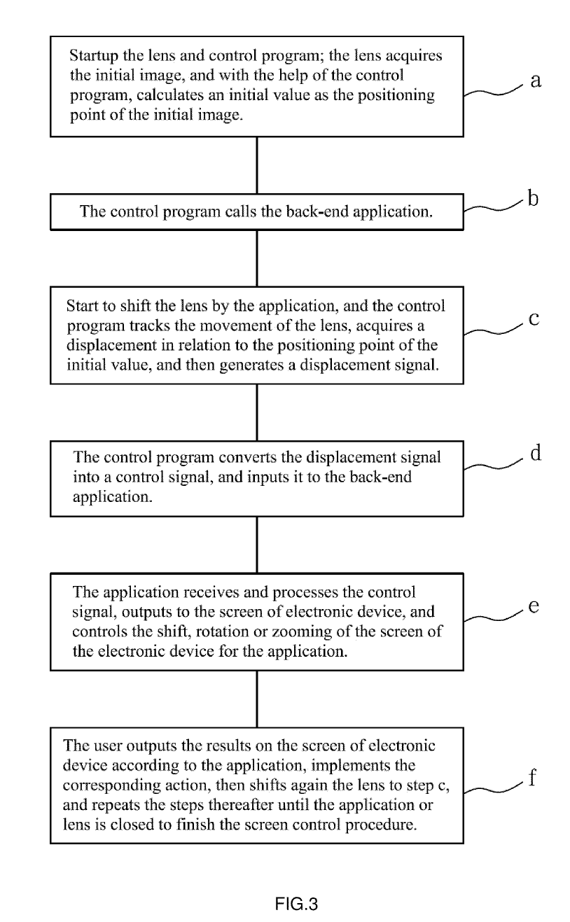

Referring to FIG. 3, the lens drive screen control method of the present invention comprises step a˜step f:
a. Startup the lens and control program; the lens acquires the initial image, and with the help of the control program, calculates an initial value as the positioning point of the initial image;
b. The control program calls the back-end application;
c. Start to shift the lens by the application, and the control program tracks the movement of the lens, acquires a displacement in relation to the positioning point of the initial value, and then generates a displacement signal;
d. The control program converts the displacement signal into a control signal, and inputs it to the back-end application;
e. The application receives and processes the control signal, outputs to the screen of electronic device, and controls the shift, rotation or zooming of the screen of the electronic device for the application;
f. The user outputs the results on the screen of electronic device according to the application, implements the corresponding action, then shifts again the lens to step c, and repeats the steps thereafter until the application or lens is closed to finish the screen control procedure.

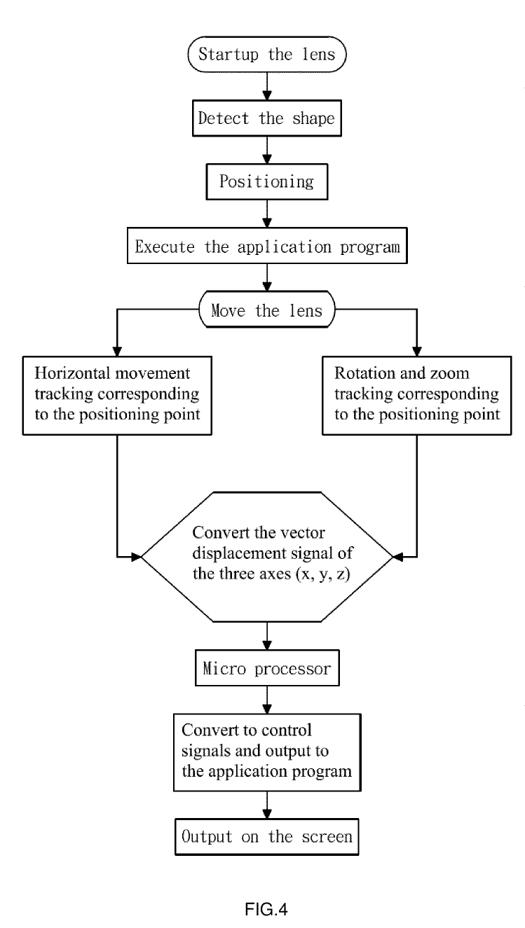

Referring to FIG. 4, a schematic view of the control program of the lens drive screen control method and system of the present invention, wherein the shape detection algorithm and target tracking algorithm for acquiring the positioning points and displacement are described below:

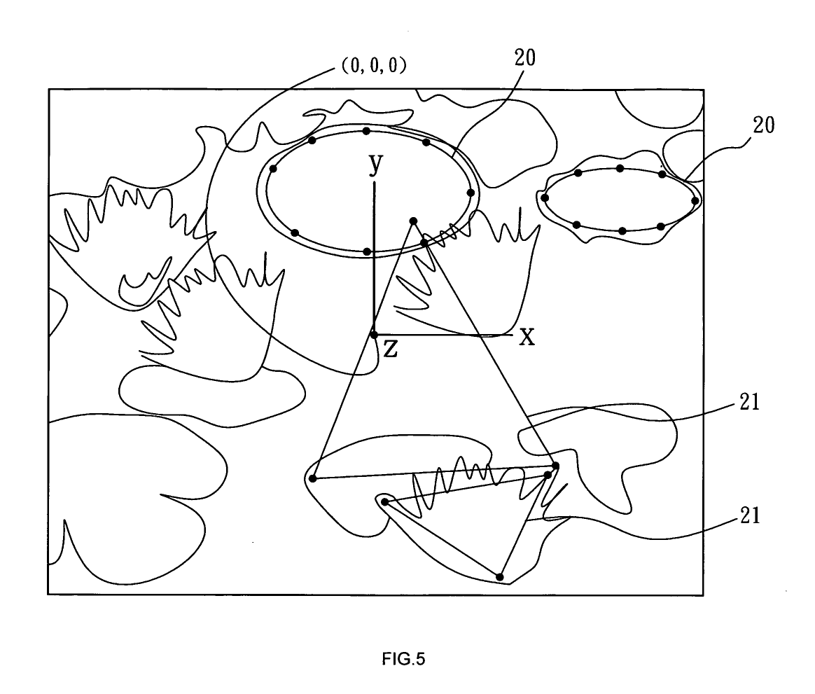

Firstly, startup the lens, and detect the elliptical 20 and triangular 21 shapes from actual space images of lens using the shape detection algorithm in the control program, as shown in FIG. 5; and, set the central point of image as (0,0,0) and take the corresponding coordinate (x,y,z) as the positioning point of initial image, implement the application, which includes but not limited to the desktop applications of game software such as racing, skiing, aircraft and shooting, or common electronic devices; according to the command, action or operating functions set by the application, the user may shift the lens by the reflex action, meanwhile the control program compares the shapes of space images obtained during the shift process of the lens by using shape detection algorithm, and also tracks the shape profiles and the shift, rotation/zooming actions in relation to the positioning point by using target tracking algorithm; moreover, the control program is used to convert the parameters and send (x,y,z) three-axle vector displacement signal to the microprocessor, which converts the displacement signal into a control signal to the application and then outputs via the screen of the electronic device, thereby controlling the shift, rotation/zooming actions of the background or targets of the applications and game software simultaneously with the shift of the lens. The positioning of the initial images is still valid as long as the application or the lens is not closed, while the continuous shift of lens only enables tracking of the shift and rotation/zooming in relation to the positioning point along with subsequent procedures.

According to the above-specified control program, the screen edge of the electronic device is further defined as max. and min. threshold of coordinate (x,y), with the central point as a zero value. The screen zooming value's upper and lower threshold is based on 50% variation of zooming-in/-out of initial screen along the direction of coordinate z.

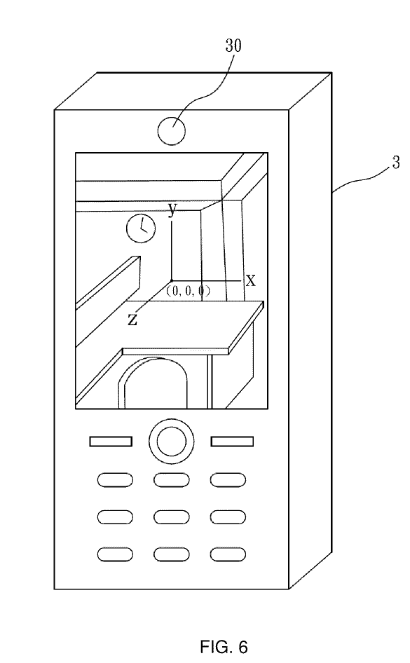

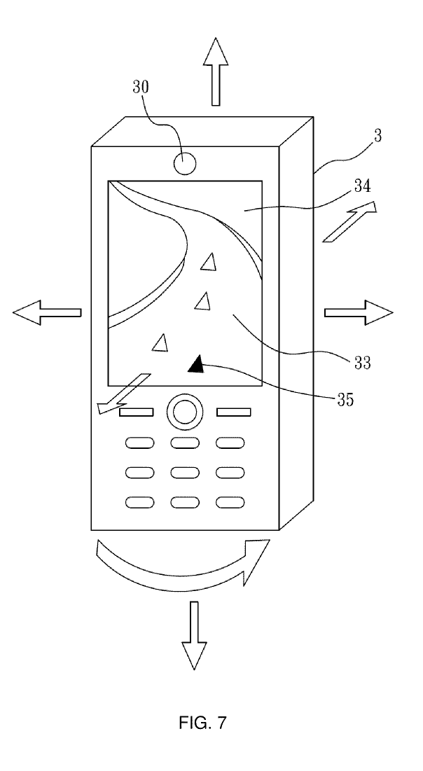

Referring to FIGS. 6, 7, schematic views of preferred embodiment that the present invention is applied to a mobile phone, wherein the mobile phone 3 is equipped with a lens 30; the user may start positioning of the initial images by starting the lens 30 and control program 31, of which the initial image and the actual space image obtained by the lens 30 are represented by an office scenario as shown in FIG. 6. If starting the application 33, e.g. a racing game, the screen 34 of the mobile phone 3 will be converted into a game screen, and the control program 31 can set the control of the target 35 and background or vehicle in the game screen. When the user shifts the mobile phone 3 along the direction of coordinate axis (x,y,z), the lens 30 will move synchronously, and the actual space image obtained by the lens 30 will change accordingly; so, the shift, rotation or zooming of the background or vehicle in the game screen can be controlled by calculating the change of images through the control program 31, as shown in FIG. 7.

The aforementioned electronic device may be PDA, mobile phone, digital camera, digital screen, computer, notebook computer or terminals with screen output functions.

The aforementioned lens may be electronic sensing component CCD or CMOS.

The aforementioned shape detection algorithm and target tracking algorithm are based on RHT technology.

If the method and system of the present invention are applied to common mobile phones with lens, only the control program of the present invention or the application specific to the control program of the present invention shall be installed, without the need of brand-new mobile phones, nor additional hardware and sensors. This could reduce greatly the cost and realize convenient game control without space limitation. Meanwhile, it could provide the reflex action of the user during game control, and the targets of game screen can be controlled synchronously with the shift, rotation or zooming of the mobile phones, thus realizing the real interaction between the user and game.

I claim:

1. A lens drive screen control method of the present invention, wherein a lens connected to electronic device is displaced, the control program generates a displacement signal to the microprocessor of electronic device for identification, and then the displacement signal is converted into a control signal to control the display screen of the electronic device by the application.

2. The method defined in claim 1, wherein this method comprises the following steps:
a. startup the lens and control program; the lens acquires the initial image, and with the help of the control program, calculates an initial value as the positioning point of the initial image;
b. the control program calls the back-end application;
c. start to shift the lens by the application, and the control program tracks the movement of the lens, acquires a displacement in relation to the positioning point of the initial value, and then generates a displacement signal;
d. the control program converts the displacement signal into a control signal, and inputs it to the back-end application;
e. the application receives and processes the control signal, outputs to the screen of electronic device, and controls the shift, rotation or zooming of the screen of the electronic device for the application;
f. the user outputs the results on the screen of electronic device according to the application, implements the corresponding action, then shifts again the lens to step c, and repeats the steps thereafter until the application or lens is closed to finish the screen control procedure.

3. The method defined in claim 1, wherein the electronic device may be PDA, mobile phone, digital camera, digital screen, computer, notebook computer or terminals with screen output functions.

4. The method defined in claim 1, wherein the lens may be electronic sensing component CCD or CMOS.

5. A lens drive screen control system of the present invention, wherein the system for the method defined in claim 1 mainly comprises:
a lens, connected to an electronic device, and used for acquiring initial images and shift images; and
a control program, loaded into an electronic device to process the images acquired from the lens; it employs shape detection algorithm and target tracking algorithm to position the initial images and track the varying shift, rotation or zooming of the lens as well as the relative displacement, and convert it into a displacement signal to the electronic device; then, the microprocessor of the electronic device converts the displacement signal into a control signal so as to control on-screen operation by the application.

6. The system defined in claim 5, wherein the electronic device may be PDA, mobile phone, digital camera, digital screen, computer, notebook computer or terminals with screen output functions.

7. The system defined in claim 5, wherein the lens may be electronic sensing component CCD or CMOS.

8. The system defined in claim 5, wherein the shape detection algorithm and target tracking algorithm are based on RHT technology.
